(19) United States
(12) Patent Application Publication
(10) Pub. No.: US 2024/0152564 A1
(43) Pub. Date: May 9, 2024

(54) Temporal Map for Neighborhood and Regional Business Vibe and Social Semantics

(71) Applicant: Google LLC, Mountain View, CA (US)

(72) Inventors: Yan Mayster, Aurora, CO (US); Bruce Bahnsen, Boulder, CO (US)

(21) Appl. No.: 18/021,690

(22) PCT Filed: Mar. 25, 2022
(86) PCT No.: PCT/US2022/021916

§ 371 Date: Sep. 28, 2023

(51) Int. Cl. G06F 16/9537; G06F 16/9535; G06Q 10/02

(52) U.S. Cl. CPC G06F 16/9537; G06F 16/9535; G06Q 10/02

(57) ABSTRACT

The present disclosure provides for searching, browsing, or navigating temporally, such that a temporal map displays events in a neighborhood or city as of a particular date or point in time. User time filters may be applied to limit results to a particular time frame, and other types of filters may be applied to limit results to particular geographic regions, types of events, characteristics of a venue such as seating capacity, or other parameters. The results may be surfaced as point of interest (POI) pins or in a contents of an information section for businesses that includes information such as address, business hours, and customer reviews. In this regard, business and social life, and the vibe of a neighborhood may be represented in online maps.

### BACKGROUND

Existing online map applications allow for searching of places having a physical address, such as businesses. If a user wants to navigate to an event, one has to first lookup the location of the event, turning it into an address or point of interest (POI), and then initiate navigation to that location. If the user wants to find out what events are happening within a given region, the user can enter a search query in a search engine and read through numerous results from various sources, many of which are typically outdated and/or not relevant to the user's interest. This can be very time consuming, frustrating, and inefficient as computing resources are devoted to numerous search attempts and interaction with results.

### BRIEF SUMMARY

The present disclosure provides for searching, browsing, or navigating “temporally.” The temporal map context provides an ability to see on the map what is happening in a neighborhood or city as of a particular date or point in time. Various events, with specific start and end times, may be dynamically displayed. User time filters may be applied to limit results to a particular time frame, and other types of filters may be applied to limit results to particular geographic regions, types of events, characteristics of a venue such as seating capacity, or other parameters. The results may be displayed as first class discoverable objects on the map. For example, the results may be surfaced as point of interest (POI) pins or in a contents of an information section for businesses that includes information such as address, business hours, and customer reviews. In this regard, business and social life, and the vibe of a neighborhood may be represented in online maps.

One aspect of the disclosure provides a method, comprising receiving, with one or more processors, a request for information associated with a particular geographic area and particular time, identifying, with the one or more processors, events scheduled to occur or having occurred within the geographic area during the particular time, identifying, with the one or more processors, venue information associated with the identified events, filtering, with the one or more processors, the identified events to produce a reduced subset of events for display, and providing for display, with the one or more processors, the reduced subset of events and the associated venue information in relation to geographic information associated with the events.

According to some examples, the venue information may include information indicating a number of people the venue is capable of accommodating.

Providing the reduced subset of events for display may include, for example, providing a graphic for each event in the reduced subset as an overlay on a map. Filtering the identified events may be based on one or more user preferences. Such user preferences may be explicit preferences input by the user, or implicit preferences that are determined based on passive cues from the user, historical information for the user, etc. The preferences may be indicated in a profile associated with the user.

According to some examples, a type of event information for the event may be selected for display based on one or more search criteria in the request.

According to some examples, the method may further comprise determining remaining availability for attending the event, and providing the remaining availability for the event for display in association with the event. In some examples, the method may further include automatically reserving admission to events meeting predetermined criteria.

Another aspect of the disclosure provides a system comprising one or more memories, and one or more processors in communication with the one or more memories. The one or more processors may be configured to receive a request for information associated with a particular geographic area and particular time, identify events scheduled to occur or having occurred within the geographic area during the particular time, identify venue information associated with the identified events, filter the identified events to produce a reduced subset of events for display, and provide for display the reduced subset of events and the associated venue information in relation to geographic information associated with the events.

According to some examples, the venue information may include information indicating a number of people the venue is capable of accommodating.

Providing the reduced subset of events for display may include, for example, providing a graphic for each event in the reduced subset as an overlay on a map. Filtering the identified events may be based on one or more user preferences. Such user preferences may be explicit preferences input by the user, or implicit preferences that are determined based on passive cues from the user, historical information for the user, etc. The preferences may be indicated in a profile associated with the user. In any of these examples, the user preferences may be predefined.

According to some examples, a type of event information for the event may be selected for display based on one or more search criteria in the request.

According to some examples, the one or more processors may be further configured to determine remaining availability for attending the event, and provide the remaining availability for the event for display in association with the event. According to some examples, the one or more processors may be further configured to automatically reserve admission to events meeting predetermined criteria.

Another aspect of the disclosure provides a non-transitory computer-readable medium storing instructions executable by one or more processors for performing a method, comprising receiving a request for information associated with a particular geographic area and particular time, identifying events scheduled to occur or having occurred within the geographic area during the particular time, identifying venue information associated with the identified events, filtering the identified events to produce a reduced subset of events for display, and providing for display the reduced subset of events and the associated venue information in relation to geographic information associated with the events.

### BRIEF DESCRIPTION OF THE DRAWINGS

FIG. 1A is a block diagram of an example system according to aspects of the disclosure.

FIG. 1B is a pictorial diagram of the example system of FIG. 1A.

FIG. 2 is an example screenshot illustrating an example search for temporal events and display of results according to aspects of the disclosure.

FIG. 3 is an example screenshot illustrating another example search for temporal events and display of results according to aspects of the disclosure.

FIG. 4 is an example screenshot illustrating another example search for temporal events and display of results according to aspects of the disclosure.

FIG. 5 is an example screenshot illustrating another example search for temporal events and display of results according to aspects of the disclosure.

FIG. 6 is an example screenshot illustrating another example search for temporal events and display of results according to aspects of the disclosure.

FIG. 7 is an example screenshot illustrating another example search for temporal events and display of results according to aspects of the disclosure.

FIG. 8 is an example screenshot illustrating another example search for temporal events and display of results according to aspects of the disclosure.

FIG. 9 is an example screenshot illustrating an example profile according to aspects of the disclosure.

FIG. 10 is a flow diagram illustrating an example method according to aspects of the disclosure.

### DETAILED DESCRIPTION

The present disclosure provides for a database of discoverable temporal events, wherein particular events are selected and surfaced on a map in response to a user request. Map databases may maintain details regarding POIs. Such details may include the location, hours, type and subtype, and other attributes of a POI that aid in discovery. As described herein, a database of discoverable temporal events may also be maintained. Examples of temporal events may include, for example, live entertainment, sporting events, festivals, special pricing events, limited time food menu offerings, conventions, or other types of events. Such discoverable temporal events may be correlated with POIs, and surfaced in a map application in response to a request from a user.

According to some examples, search criteria may include geographic options, timing options, event type options, and/or any of a variety of other types of options. Events may be grouped into semantic categories, with a knowledge graph providing a hierarchical structure. As such, users could have an additional semantic filter among their map options and view/search for those events on the map that fall under a specific category of interest. With such built-in map support and the breadth and versatility of the knowledge graph, businesses and groups of individuals can set up a multitude of extremely diverse and easily discoverable events, providing them with the appropriate time bounds, locations, visibility criteria, and any additional metadata, such as text announcements, websites, etc. Consequently, a user could request to see the map of what's happening in their town or the city they're visiting at present or a week into the future, add filters that would limit the display to selected types or subtypes of events. According to some examples, events having an associated time that has passed may remain visible in map views for historical time intervals.

Introducing events and event overlays onto the map provides the ability to query historical, present, and future data on a region-by-region basis for many interesting statistics, such as event density, broken down by event type, time of day, day of week, month, etc. It also allows for analysis of event relationships, such as how certain groups of events are related and how the appearance of an event of one type affects the likelihood of events of other types nearby. Businesses may thus view and analyze publicly visible events to plan their next offerings and strategize around how to attract the greatest number of customers to an individual event or to maintain a stable clientele on an ongoing basis.

### Example Systems

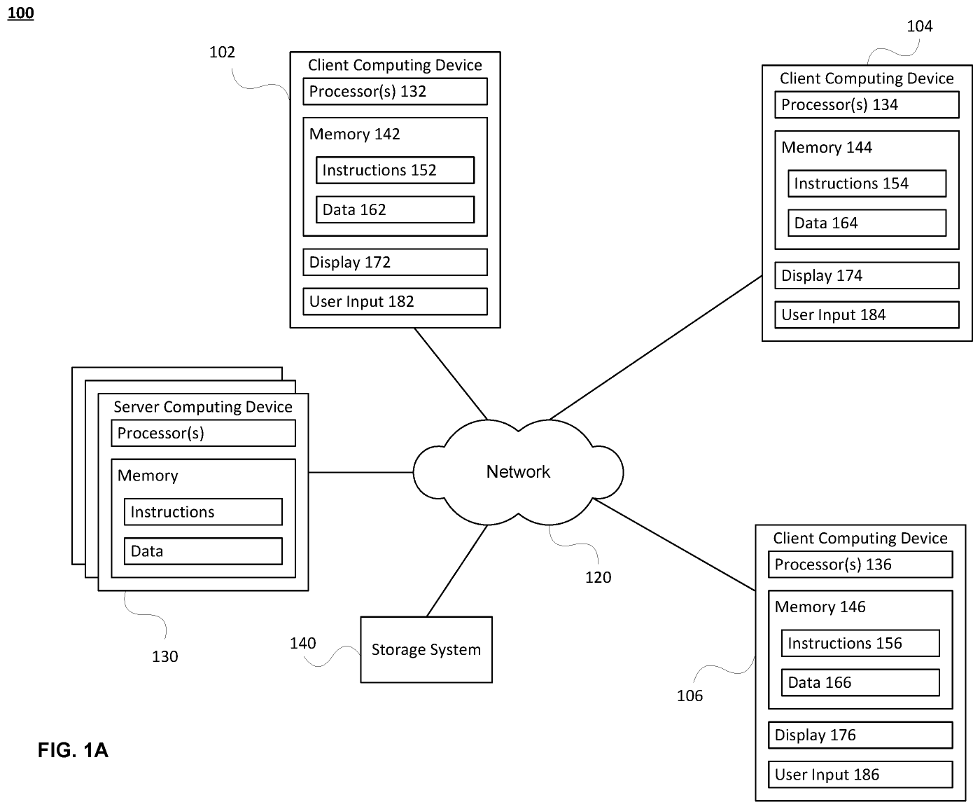

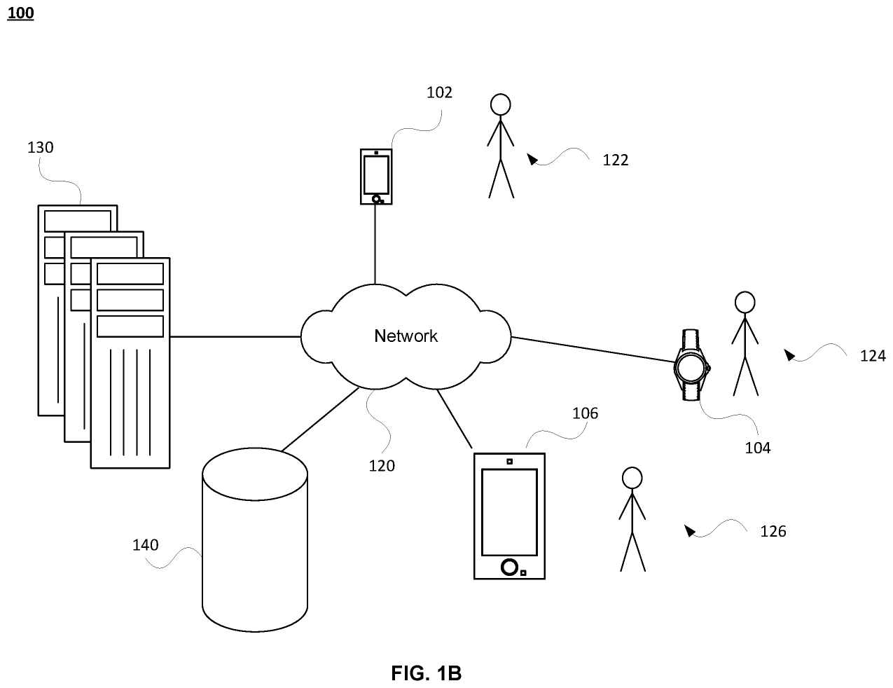

FIG. 1A illustrates an example system 100 in which the features described above may be implemented. It should not be considered limiting the scope of the disclosure or usefulness of the features described herein. In this example, system 100 may include a plurality of devices 102, 104, 106, server computing device 130, storage system 140, and network 120.

Each of devices 102, 104, 106 may include one or more processors 132, 134, 136, memory 142, 144, 146, data 162, 164, 166 and instructions 152, 154, 156. Each of devices 102, 104, 106 may also display 172, 174, 176 and user input 182, 184, 186.

Memory 142, 144, 146 of devices 102, 104, 106 may store information that is accessible by processor 132, 134, 136. Memory 142, 144, 146 may also include data that can be retrieved, manipulated or stored by the processor 132, 134, 136. The memory 142, 144, 146 may be of any non-transitory type capable of storing information accessible by the processor 132, 134, 136, including a non-transitory computer-readable medium, or other medium that stores data that may be read with the aid of an electronic device, such as a hard-drive, memory card, read-only memory (“ROM”), random access memory (“RAM”), optical disks, as well as other write-capable and read-only memories. Memory 142, 144, 146 may store information that is accessible by the processors 132, 134, 136, including instructions 152, 154, 156 that may be executed by processors 132, 134, 136, and data 162, 164, 166.

Data 162, 164, 166 may be retrieved, stored or modified by processors 132, 134, 136 in accordance with instructions 152, 154, 156. For instance, although the present disclosure is not limited by a particular data structure, the data 162, 164, 166 may be stored in computer registers, in a relational database as a table having a plurality of different fields and records, XML documents, or flat files. The data 162, 164, 166 may also be formatted in a computer-readable format such as, but not limited to, binary values, ASCII or Unicode. By further way of example only, the data 162, 164, 166 may comprise information sufficient to identify the relevant information, such as numbers, descriptive text, proprietary codes, pointers, references to data stored in other memories (including other network locations) or information that is used by a function to calculate the relevant data.

The instructions 152, 154, 156 can be any set of instructions to be executed directly, such as machine code, or indirectly, such as scripts, by the processor 132, 134, 136. In that regard, the terms “instructions,” “application,” “steps,” and “programs” can be used interchangeably herein. The instructions can be stored in object code format for direct processing by the processor, or in any other computing device language including scripts or collections of independent source code modules that are interpreted on demand or compiled in advance. Functions, methods and routines of the instructions are explained in more detail below.

The one or more processors 132, 134, 136 may include any conventional processors, such as a commercially available CPU or microprocessor. Alternatively, the processor can be a dedicated component such as an ASIC or other hardware-based processor. Although not necessary, computing devices 102, 104, 106 may include specialized hardware components to perform specific computing functions faster or more efficiently.

Although FIG. 1A functionally illustrates the processor, memory, and other elements of computing devices 102, 104, 106 as being within the same respective blocks, it will be understood by those of ordinary skill in the art that the processor or memory may actually include multiple processors or memories that may or may not be stored within the same physical housing. Similarly, the memory may be a hard drive or other storage media located in a housing different from that of the computing devices 102, 104, 106. Accordingly, references to a processor or computing device will be understood to include references to a collection of processors or computing devices or memories that may or may not operate in parallel.

Display 172, 174, 176 and other displays described herein may be any type of display, such as a monitor having a screen, a touch-screen, a projector, or a television. The display 172, 174, 176 of the one or more computing devices 102, 104, 106 may electronically display information to a user via a graphical user interface (“GUI”) or other types of user interfaces. For example, as will be discussed below, display 172, 174, 176 may electronically display a map interface with turn-by-turn directions between two geographic locations, corresponding road segments, and waypoints to maximize the overall probability of finding an open parking spot when searching in a predefined area surrounding the final geographic location.

The user inputs 182, 184, 186 may be a mouse, keyboard, touch-screen, microphone, or any other type of input.

The devices 102, 104, 106 can be at various nodes of a network 120 and capable of directly and indirectly communicating with other nodes of network 120. Although three (3) computing devices are depicted in FIG. 1A, it should be appreciated that a typical system can include one or more computing devices, with each computing device being at a different node of network 120. The network 120 and intervening nodes described herein can be interconnected using various protocols and systems, such that the network can be part of the Internet, World Wide Web, specific intranets, wide area networks, or local networks. The network 120 can utilize standard communications protocols, such as WiFi or Bluetooth, that are proprietary to one or more companies. Although certain advantages are obtained when information is transmitted or received as noted above, other aspects of the subject matter described herein are not limited to any particular manner of transmission.

In one example, system 100 may include one or more server computing devices having a plurality of computing devices, e.g., a load balanced server farm, that exchange information with different nodes of a network for the purpose of receiving, processing and transmitting the data to and from other computing devices. For instance, one or more server computing devices 130 may be a web server that is capable of communicating with the one or more client computing devices 102, 104, 106 via the network 120. In addition, server computing device 130 may use network 120 to transmit and present information to a user of one of the other computing devices 102, 104, 106. Server computing device 130 may include one or more processors, memory, instructions, and data. These components operate in the same or similar fashion as those described above with respect to computing devices 102, 104, 106.

As shown in FIG. 1B, each device 102, 104, 106 may be a personal computing device intended for use by a respective user 122, 124, 126, and have all of the components normally used in connection with a personal computing device including a one or more processors (e.g., a central processing unit (CPU)), memory (e.g., RAM and internal hard drives) storing data and instructions, a display (e.g., a monitor having a screen, a touch-screen, a projector, a television, or other device such as a smart watch display that is operable to display information), and user input devices (e.g., a mouse, keyboard, touchscreen or microphone). The devices may also include a camera for recording video streams, speakers, a network interface device, and all of the components used for connecting these elements to one another. Devices 102, 104, 106 may be capable of wirelessly exchanging or obtaining data over the network 120.

Although the client computing devices may each comprise a full-sized personal computing device, they may alternatively comprise mobile computing devices capable of wirelessly exchanging data with a server over a network such as the Internet. By way of example only, devices 102, 104, and 106 may be mobile phones or devices such as a wireless-enabled PDA, smartphones, a tablet PC, a wearable computing device (e.g., a smartwatch, AR/VR headset, smart helmet, etc.), or a netbook that is capable of obtaining information via the Internet or other networks.

Storage system 140 may store various types of information. For instance, the storage system 140 may store data or information related to POIs for retrieval in response to a search for an event. As used herein, POIs may include any location, or destination, that a user can visit, such as a park, green space, restaurant, theater venue, amusement park, shopping center, etc. The POI information may include, for example, contact information, hours of operation, ratings, etc. associated with the POI. The POI information may further include event information for one or more events that were held or that are scheduled to be held at a future time at the POI. Such event information may include, by way of example and not limitation, grand opening, sales, promotions, entertainment events such as music, theatre performances, comedy shows, or the like, sporting events, festivals, parades, garage/estate sales, art/museum exhibits, limited-time menu offerings, etc.

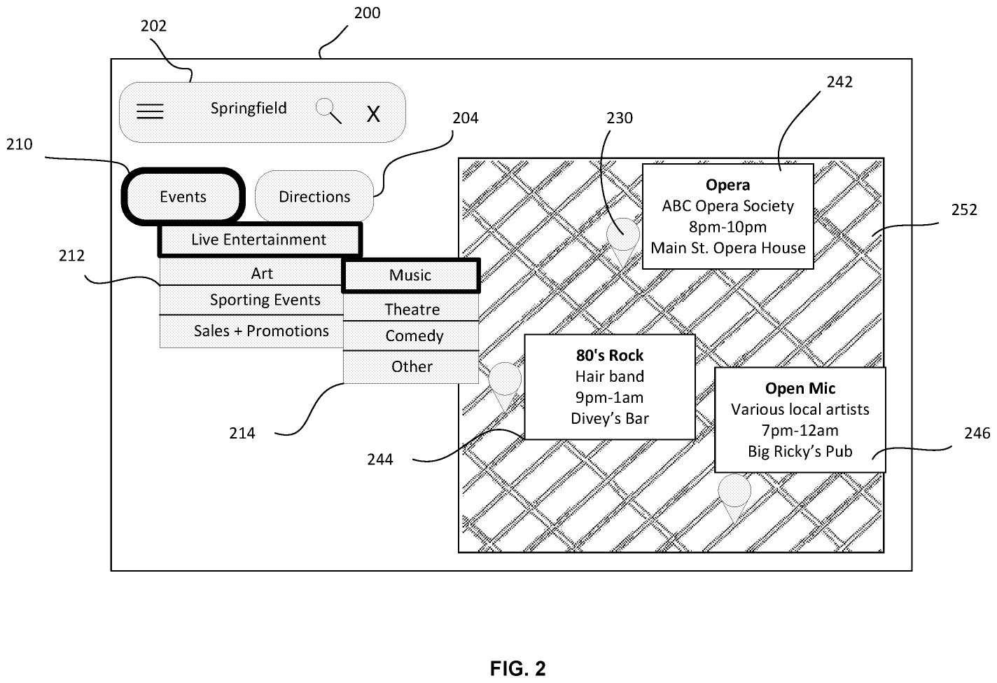

FIG. 2 illustrates an example screenshot 200 including a geographic search field 202 and a map portion 252. The geographic search field 202 may be capable of accepting input indicating a geographic region. Examples of such input may include, without limitation, a town, city, zip code, particular POI, or instruction to use a current location of a user device, such as “near me.” When such input is entered into the search field 202, the map portion 252 may display the geographic region corresponding to the input. For example, if the city of “Springfield” is entered into the search field 202 as shown in FIG. 2, a map of Springfield may be displayed in the map portion 252. Such map take any of a variety of forms, such as a traditional two-dimensional roadway depiction map, a bird's eye view map, satellite view, street-level view, three-dimensional view, etc.

In the example shown, the screenshot 200 includes a plurality of request buttons 204, 210 through which commands can be received to perform a particular action. By way of example, “directions” request button 204, when selected, may cause a prompt to appear seeking input of a starting point such that driving, walking, public transportation, or other directions to the geographic region can be generated from the starting point. Event request button 210, when selected, may cause an indication of temporal events within the geographic region to surface on the map portion 252. Such temporal events may be past events, present events, or future events. According to some examples, discussed further below, particular timeframes for the events may be received as input from a user, and the temporal events are filtered such that only events occurring within the particular timeframes are indicated in the map portion 252.

According to some examples, the temporal events may be filtered, such as to provide only particular types of temporal events specified in a request from the user. In the example shown, a pre-populated menu may be displayed offering options for selection. Such options may include, for example, event type and sub-type. For example, the pre-populated menu can be a hierarchical drop-down menu as shown in FIG. 2 with a main menu 212 and one or more sub-menus 214. In this example, the main menu 212 includes a variety of event types, such as live entertainment, art, sporting events, and sales and promotions. It should be understood that these are merely examples and other types of events may be included in the menu. Events may be public or private. Private events may be limited to specific users or groups, such that the results are only visible to the limited specific users or groups and are not accessible by the general public. An example private event could be a dinner reservation among friends, where the reservation is entered by one of the attending parties and publication of the event to the limited group of friends is authorized by the group of friends. Examples of public events may include cooking classes, book signings, or anything that a member of the public could attend.

When a type is selected from the main menu 212, such as selection of live entertainment, a sub-menu 214 may be displayed providing a variety of sub-types that correspond to the selected type. For example, for the main type of live entertainment, the sub-types in sub-menu 214 may include music, theatre, comedy, or other. According to some examples, even further refinement is possible. For example, a selection of music may cause a further sub-menu to be displayed indicating various types of music, such as rock, pop, classical, jazz, opera, etc. While the pre-populated menu in this example is a hierarchical drop-down list, it should be understood that any of a variety of other menu formats are possible. For example, the menu may include a collection of icons, text bubbles, etc.

Results for the event search may be displayed in the map portion 252. The results may be indicated in any of a variety of forms. In the example of FIG. 2, the results are indicated as pins 230 with corresponding information boxes 242, 244, 246. According to some examples, an amount of information surfaced may vary based on a number or density of results. According to some examples, information boxes 212, 244, 246 may be displayed only for events most closely matching user preferences, while other events retrieved in the search are displayed with less information, such as location pins only. The results may be displayed and updated each time an event type or sub-type is selected. For example, while many events may be displayed in response to a selection of live entertainment, the map portion 252 may be updated to display fewer results when the sub-type of music is selected.

The information boxes 242, 244, 246 may display any of a variety of types of information. As shown, the information boxes 242, 244, 246 display a type of music, a name of the performer, a time of the performance, and a location of the performance According to other examples, more or less information may be displayed.

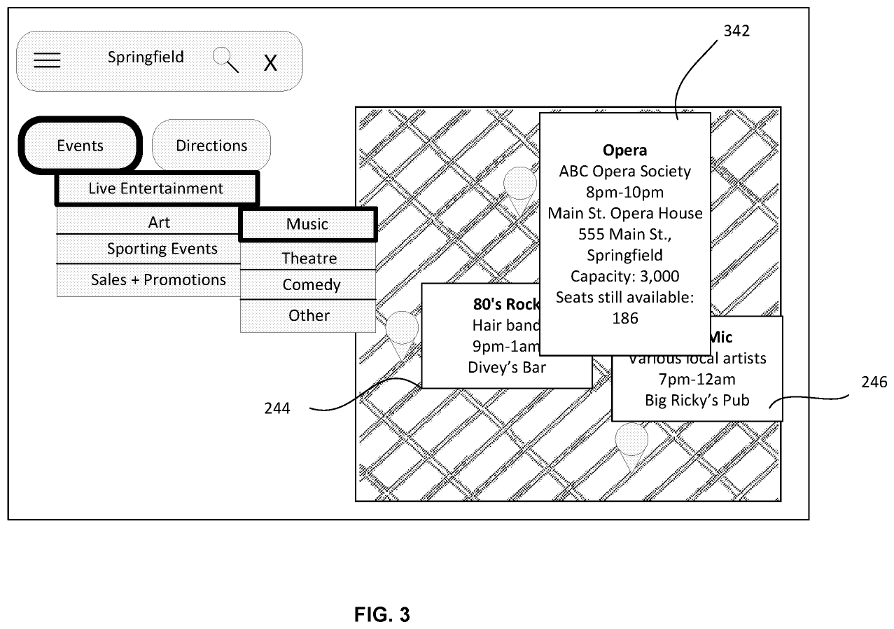

FIG. 3 illustrates an example where more information is displayed for one or more of the search results. In this example, detailed information box 342 displays additional information as compared with information box 242 of FIG. 2. Detailed information box 342 may be displayed, according to some examples, in response to user interaction with the less detailed information box 242 of FIG. 2. In other examples, detailed information box 342 may be displayed for all search results. In yet further examples, the detailed information box 342 may be displayed for selected results that most closely match preferences for a user that requested the search. Such preferences may be explicitly set by the user, informed by passive cues, historical information, or the like. In an example, preferences may be predefined by the user such that search results that are objectively less relevant to the user may be automatically displayed in a less prominent manner That is to say, the detailed information box 342 may not be displayed automatically for search results that do not match the users preferences, and may only be displayed automatically for search results that do match the users preferences. The automatic reduction in display prominence of objectively less relevant search results improves both the use of screen space and processing efficiency of displaying the search results, since results that are objectively less relevant to the user are displayed in a reduced manner. As such, relevant search results may be displayed more efficiently, quickly and clearly.

The additional information displayed in detailed information box 342 may include additional venue information. For example, the additional venue information can include a capacity, remaining availability, an actual or predicted busyness level for the event, links to a website or reservation system for the venue, description of the venue, such as ambiance, décor, noise level, vibe, etc., or any of a variety of other information. The capacity may indicate a number of people that the venue can accommodate. Such information may give the user a sense of how crowded the venue will be for the event. Some users may feel less comfortable around large crowds, for example, and prefer smaller venues. The remaining availability and busyness level for the event may provide similar indications regarding how crowded the event will be. Due to this, improved safety information is provided as part of the search results as the user is informed how busy the venue or area is. The remaining availability information, for example, may provide an indication of whether the event will be near a maximum capacity for the venue or whether many tickets will remain unsold. It additionally provides an indication to the user of timing to act to secure admission to the event. For example, if hundreds of seats remain available for a concert, the user likely has more time to act as compared to a situation where only a few seats remain available. The busyness information may indicate how many people were or will be at the event. The busyness information can be illustrated using a picture captured at the venue, using a graph illustrating levels of busyness for the venue at various times, or by any other mechanism.

According to some examples, the type of information displayed in the information boxes 342, 244, 246 may correspond to parameters specific to the search. For example, for a search for a live performance, venue information such as capacity, remaining availability, admission protocols such as minimum age requirements, dress codes, or other such information may be pertinent to display. In contrast, for other types of events, such as an outdoor pop-up market, other types of information, such as a types of goods sold, may be more relevant and therefore may be displayed.

The information boxes illustrated in FIGS. 2-3 are just one example of how details can be displayed for a particular event and/or venue. In other examples, information can be output in any of a variety of other formats.

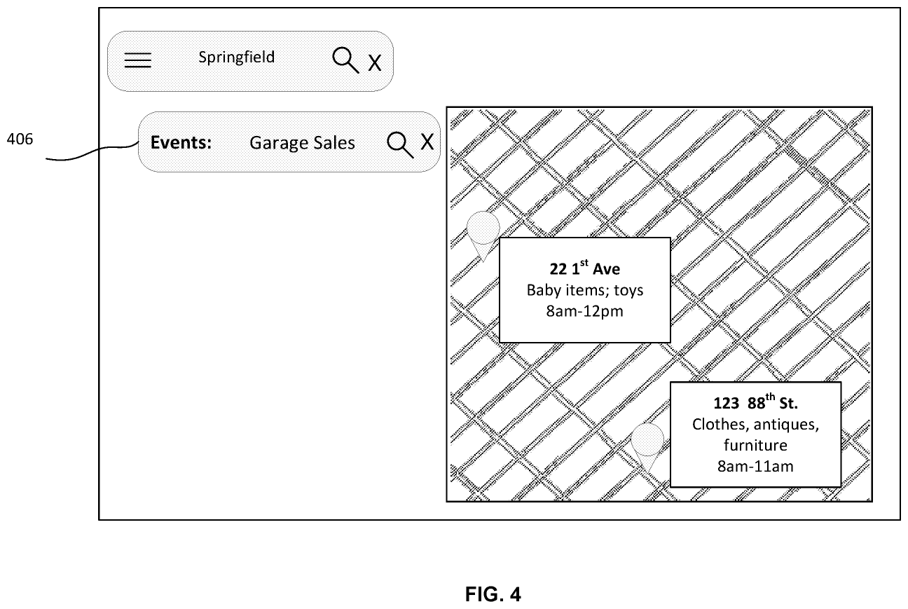

FIG. 4 illustrates another example of an event search tool, and how search requests can be entered using the tool. In this example, rather than a pre-populated menu, a free-text event search field 406 is provided. Such free-text event search field 406 may accept search queries having varying level of details. For example, the field 406 can accept a general request such as “all” events or all “live entertainment” events, or more specific requests, such as “live music” or “live rock music” or “live XYZ cover band.” As shown in the example of FIG. 4, the search field 406 receives a text search for garage sales. In response, garage sales occurring within the geographic region are displayed.

Information used for surfacing the events, such as the garage sales of FIG. 4, may be collected from owners of the event or authorized representatives. For example, an owner or resident of a house that is hosting the yard sale may create an entry in a map database listing pertinent information for the garage sale, such that it can be included in search results. The pertinent information can include, for example, the location, timeframe, types of items to be sold, preferred payment options, etc. When creating the entry, the owner or resident's identity may be verified, such that only owners or residents can authorize publication of events occurring at the residence. The owner or resident may further set parameters for the publication for additional security. For example, such parameters may provide that the publication automatically expires after the established timeframe for the event, such that it will not appear in subsequent search results.

While in this example of using the free-text event search field 406 the event searched was a garage sale, in other examples, the search field 406 can accommodate any of a variety of types of events, such as sales or promotions at businesses, sporting events, local celebrations or festivals, art exhibits, performances, etc. According to some examples, the type of information displayed with the search results may be determined based on the type of event searched or parameters for the search. For example, for the garage sale example of FIG. 4, the type of information displayed includes the type of goods to be sold at each garage sale. In contrast, for the live music example of FIG. 3, the type of information includes venue information such as seating capacity, a remaining number of seats available, etc. According to some examples, the additional information may be displayed when search parameters are defined, such as to filter the search results. For example, if a search request specifies garage sales with toys, the additional information may be provided only for results where the owner indicated toys would be sold.

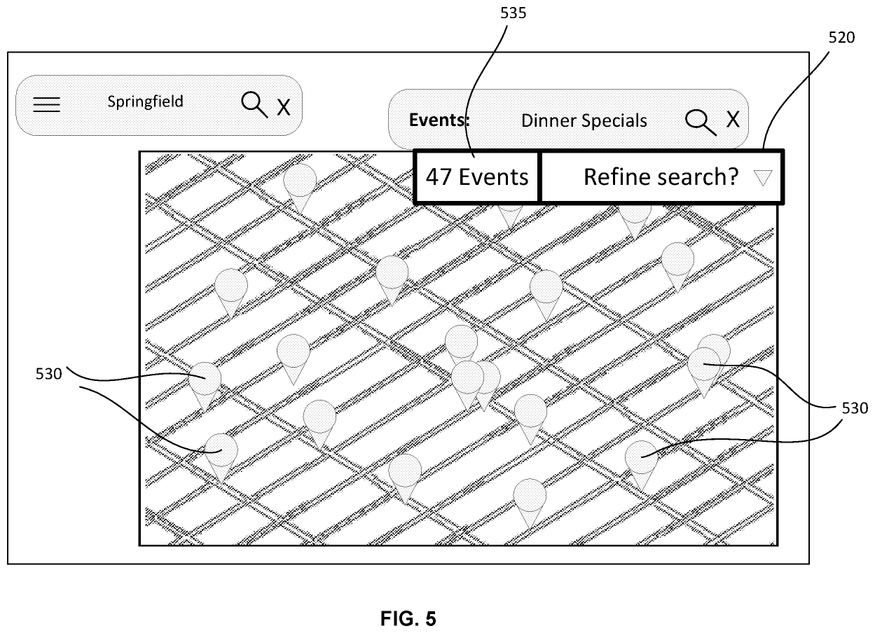

FIG. 5 illustrates another example of how search results may be displayed. In this example the search results may be displayed as location markers 530 only, without information boxes. Such view may give the user a visual indicator of a density of events within the timeframe, without displaying the specific information associated with each event. The user may interact with any of the location markers 530, such as by hovering over it or clicking on it, to display additional event information for the specific event associated with that location marker.

As shown in this example, metric information 535 may be displayed with the results. The metric information 535 may indicate, for example, a number of results matching the type of event, geographic location, and timeframe included in the search request. In other examples, the metric information 535 may include other types of information, such as a frequency of occurrence of events, most popular events based on measured or expected busyness levels, or any other type of metric.

According to some examples, a refinement icon 520 may be displayed prompting further refinement of search results. Such refinement icon 520 may be displayed each time results are displayed, or only when a number or density of search results is greater than a threshold value. While the refinement icon 520 is illustrated as a drop-down menu, it can be any other type of menu or open search field. By providing the refinement icon 520 only when the number of density of search results is greater than a threshold value, screen space is more efficiently used as the refinement icon 520 is not shown unnecessarily.

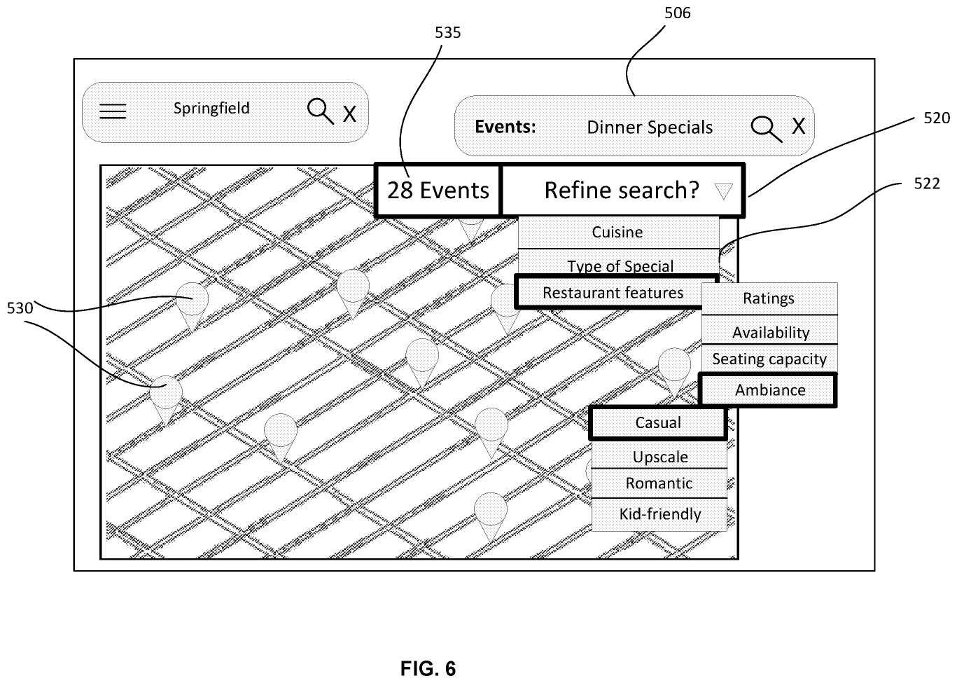

FIG. 6 illustrates an example hierarchical drop-down menu 522 associated with the refinement icon 520, the menu 522 including pre-populated options. The options in the menu 522 may each correspond to a search entered in search field 506, regardless of whether the search field is a pre-populated menu or a free-text search field. As shown, the search query entered in the search field 506 is for dinner specials, and therefore the refinement icon 520, when selected, provides the menu 522 allowing for refinement based on any of a variety of characteristics that may be selected by the user. Such characteristics include a type of cuisine, a type of special being offered, restaurant features, etc. Each category may include one or more sub-menus with further refinements, such that the search can be made more detailed. With each refinement, the results may be updated. For example, results may be further filtered such that a reduced number of location markers 530 are displayed. Additionally, the metrics 535 may be updated.

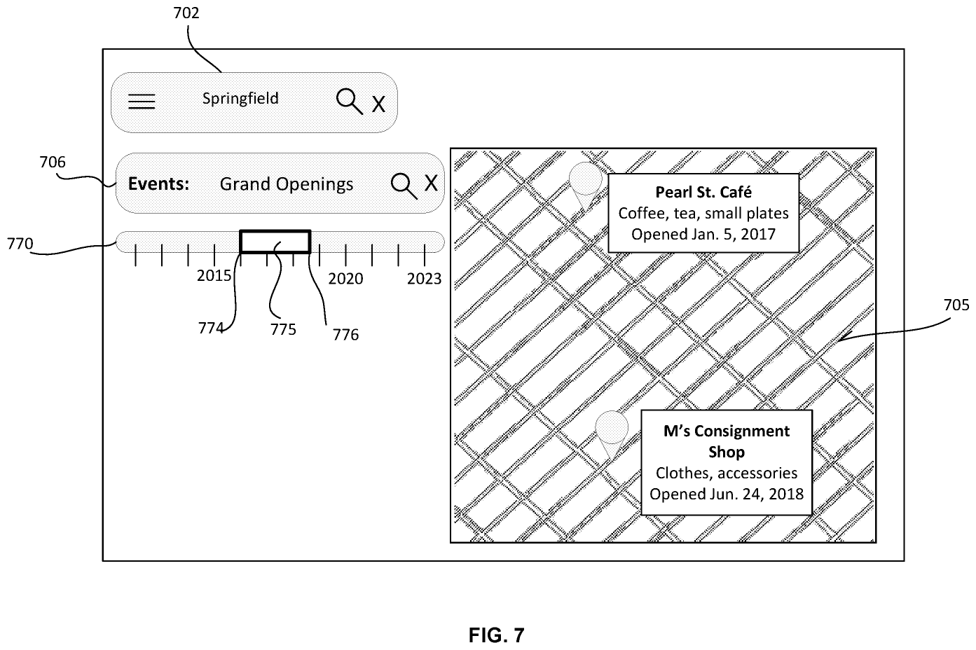

FIG. 7 illustrates an example of how a timeframe may be selected for inclusion in a search request. In this example, a timeline 770 is provided including an adjustable selection bar 775. The adjustable selection bar 775 may be slid to the left or right along the timeline 770 to capture earlier or later dates. Moreover, the adjustable selection bar 775 may be expanded or contracted, such as by adjusting either or both of beginning edge 774 or ending edge 776, such as to capture wider or narrower ranges of time. Results displayed corresponding to geographic search field 702, event search field 706, and timeframe selection bar 775 may be displayed in map portion 705. The results may be displayed along with information selected based on the search criteria. For example, as the event search query is for “grand openings” the information displayed with the search results may indicate a date each establishment celebrated its grand opening.

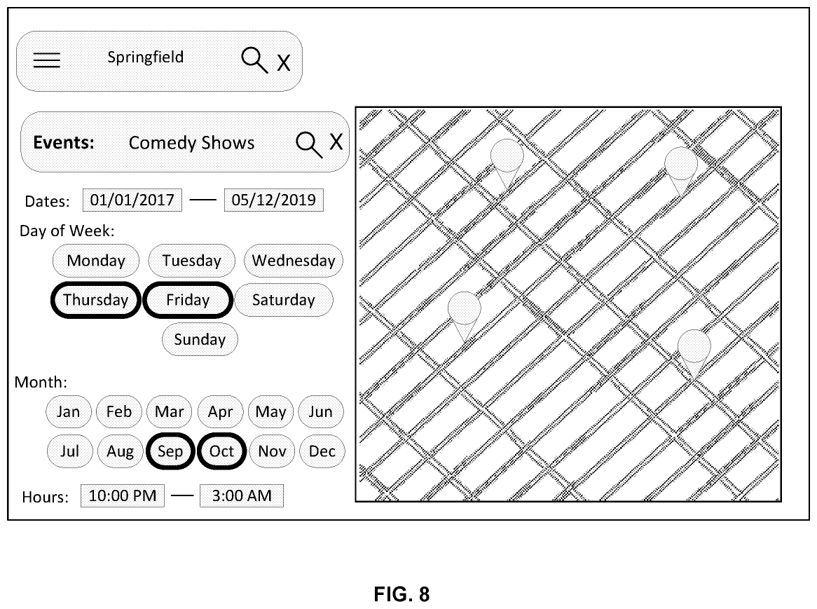

FIG. 8 illustrates another example of timeframe selection. According to this example, discrete values for the timeframe may be selected. Such discrete values may include, for example, particular dates, days of week, months, hours, etc. For example, as shown, a user may select to view comedy shows in the geographic region between Jan. 1, 2017 and May 12, 2019 that were performed on Thursdays or Fridays in September or October between 10 PM-3 AM. It should be understood that any of the various discrete values may be selected. According to some examples, selections may be made in any one or two categories of discrete values while others can be left unselected.

Selection of such discrete values for the temporal events can allow for visualization of metrics. As one example, someone considering opening a venue to specialize in hosting wedding ceremonies and banquets may want to see how many such events take place in a month in their neighborhood/town. Thus, they may start by measuring the businesses in the area in terms of wedding event traffic as a sum over all such events. For each business, B_i, a sum over all events V associated with the event semantic concept, or knowledge graph subroot, can be calculated as:

E_k:S_{B_i,E_k}=Sum(C_v(B_i,E_k))

for all B_i's, where C(B_i, E_k) is the count of events of type E_k at B_i.

In some cases, users may be interested in knowing the event hours and thus compute:

D_{B_i,E_k}=Sum(D_v(B_i,E_k))

where D_v measures the duration in hours of the event v of type E_k at business B_i, and the sum is over all events V at B_i.

Furthermore, for each neighborhood N_x, the semantics of that neighborhood can be measured by aggregating across all businesses B_i in that neighborhood using the following computation:

D_{E_k}=Sum_{i=1 . . . n}(D_{B_i,E_k})

Having measurements at this level allows helps businesses plan their services or the opening of new business locations and helps users search for destinations and areas that are more likely to fit their wants and interests. For instance, if a customer is looking for more yoga class options in an area A, then all neighborhoods N contained in A can be ranked for the semantic characteristics of being popular for yoga. Given the temporal nature of events, different neighborhood semantics can be measured at different times of the day. For example a neighborhood might have totally different semantics in the morning as compared with late night. In this way, more relevant user recommendations can be served.

This semantic understanding of each area and neighborhood is a valuable signal for the businesses themselves. As new semantic information becomes available about the kinds of events that are typical for a neighborhood, it gives existing businesses an avenue for understanding the kinds of customers that frequent the area or identify potential customer needs that may go unaddressed. This new understanding also gives rise to additional advertising streams.

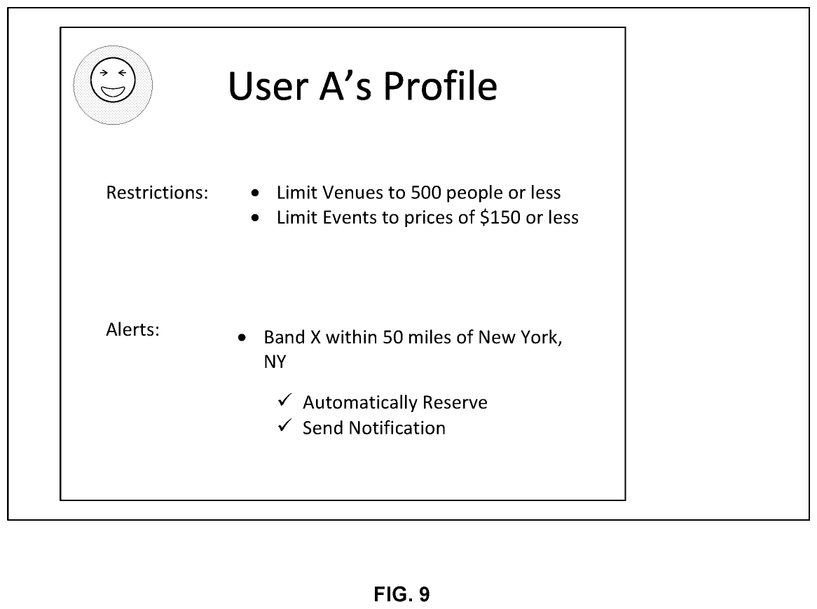

FIG. 9 illustrates an example user profile. User profiles may be created for each user, and may be updated by the user to indicate user preferences. According to some examples, the profile may include preferences that are inferred based on passive cues from the user, such as historical information, if the user has authorized such use of the information.

As shown in the present example, the user profile may include one or more restrictions that may be used to filter search results for event searches submitted by the user. For example, as shown, User A specified that event search results should be limited to venues hosting 500 people or less and events with prices of 150 or less. In this regard, each time User A submits an event search request, any events having parameters outside these restrictions may be filtered from the search results. In addition to providing an improved user experience that is tailored to the user's preferences and requires less user effort to look through results, this provides for reduced network resources in that fewer results are displayed, thereby conserving power and bandwidth, and fewer follow-up searches are required to arrive at the user's desired view, thereby resulting in additional conservation of power and bandwidth. While the restrictions in this example relate to price and capacity, it should be understood that additional or fewer filters may be applied.

As shown in the present example, alerts can also be set up by the user, such that a predetermined action can be automatically taken in response to detection of a specified event. By way of example, the User A can set up an automatic alert when Band X is scheduled to perform within a predetermined distance of a selected location, in this example 50 miles of New York City. The predetermined responsive action in this example includes sending a notification to the User A, such as a text message, push notification, or the like. The predetermined responsive action further includes automatically reserving a seat at the performance that meets the set parameters. For example, the map application through which the user's profile is set can be integrated with ticketing services for events, such that tickets can be automatically purchased when particular search criteria are met.

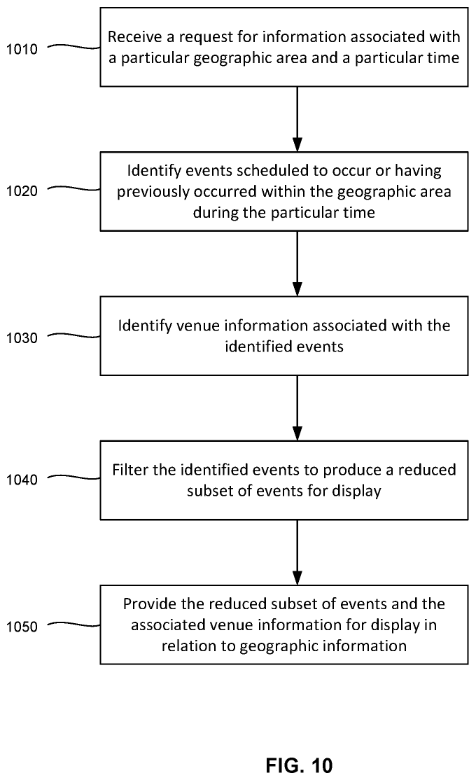

FIG. 10 illustrates an example method of displaying temporal events in association with geographic locations. While the operations are described in a particular order, it should be understood that operations may be performed in a different order or simultaneously. Moreover, operations may be added or omitted.

In block 1010, a request is received for information associated with a particular geographic area and a particular time. For example, the request may specify a particular town, street, city, state, country, postal code, coordinates, landmark, or any other information that may be used to identify a geographic region. The particular time may be explicitly input or may be implicit. For example, an implicit time may be inferred based on search parameters, user profile information, or any other information. For example, a search for “dinner specials near me” submitted at approximately 4 PM on a given day may be used to infer that the timeframe for the search should include hours approximately dinner time on the given day or future dates. Explicit times may be input via any mechanism, such as free text, selection of discrete values in a menu, adjustment of a sliding timeline, etc.

In block 1020, events having occurred, or scheduled to occur, within the geographic region during the particular time are identified. For example, search parameters from the request may be applied to a database of temporal events, and events meeting the criteria may be selected.

In block 1030, venue information associated with the events may be identified. Such venue information may include, for example, an event site, such as a name, address, and imagery of the event site. In some examples, such venue information may include additional details, such as a size of the venue, e.g., based on maximum seating capacity, square footage, or other indicia, an availability to attend the event, e.g., a number of tickets remaining, an ambiance of the venue, e.g., whether it is upscale, casual, lively, quiet, historical, modern, etc., or any other indicia.

In block 1040, prior to displaying the search results, the identified events may be filtered to produced a reduced subset of events for display. For example, the events may be filtered based on explicit or implicit search criteria. In other examples, the events may be filtered based on explicit or implicit user preferences. In some examples, the events may be filtered based on additional search criteria submitted by the user, such as through one or more prompts. By filtering the events based on user preferences, events that are less relevant or irrelevant to the user are prevented from being displayed. In an example, the user preferences are predefined explicitly by the user, and as such the events that are objectively less or not relevant to the user are prevented from display. As this is objective based on the user's predefined preferences, the filtered search results are objectively more relevant and improved as less relevant results are omitted from the search results. Not only does this improve the search results, but also a more efficient use of display space is provided as the less relevant results are not displayed.

In block 1050, the reduced subset of events may be provided for display in association with venue information and in relation to the geographic area. For example, the events may be displayed on a map, each event positioned on a portion of the map that corresponds to a location of the venue. According to some examples, additional venue information may be displayed, for example depending on search parameters or user interaction with an initial set of results. According to further examples, the information displayed with the results may be selected based on the search criteria. For example, searches for a first type of event may results in display of a first type of information, while searches for a second type of event may results in display of a second type of information. According to other examples, specification of criteria, such as search restrictions, in a user profile may cause information specific to those restrictions to be displayed with the results.

Providing for searching and displaying of temporal events as described above is beneficial in that it provides pertinent information to businesses and individual users in a computationally efficient manner. In particular, rather than requiring a user to search for locations, and then visit websites for each location to determine events happening at a particular time, the user can search for all events occurring in a particular area. In this manner, the user is automatically shown those events that are occurring in the relevant time frame as part of the search results, providing a dynamic and relevant search. By reducing the number of sites needed to visit for such information, computing resources such as bandwidth, power, and other network resources are conserved. Moreover, the system and method provided herein provide for applying specific filters that may be implicit or explicitly set by the user. By filtering the results prior to display, and thereby reducing the number of less pertinent results displayed, additional computing resources are conserved as only the filtered results need be rendered and displayed on a user device. Even further, according to some examples the type of information displayed with the results may be automatically selected based on the search criteria. By automatically selecting and displaying only the more pertinent information for each particular search, additional computing resources are conserved.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method, comprising:
receiving, with one or more processors, a request for information associated with a particular geographic area and particular time;
identifying, with the one or more processors, events scheduled to occur or having occurred within the geographic area during the particular time;
identifying, with the one or more processors, venue information associated with the identified events;
filtering, with the one or more processors, the identified events to produce a subset of events for display; and
providing for display, with the one or more processors, the subset of events and the associated venue information in relation to geographic information associated with the events.

2. The method of claim 1, wherein the venue information comprises information indicating a number of people the venue is capable of accommodating.

3. The method of claim 1, wherein providing the subset of events for display comprises providing a graphic for each event in the subset as an overlay on a map.

4. The method of claim 1, wherein filtering the identified events is based on one or more user preferences.

5. The method of claim 4, further comprising determining, with the one or more processors, the one or more user preferences based on passive cues from the user.

6. The method of claim 4, further comprising determining, with the one or more processors, the one or more user preferences based on historical information for the user.

7. The method of claim 4, wherein the one or more user preferences are indicated in a profile associated with the user.

8. The method of claim 1, further comprising providing for display event information, wherein a specific type of event information selected for display varies based on one or more search criteria in the request.

9. The method of claim 1, further comprising:
determining remaining availability for attending the event; and
providing the remaining availability for the event for display in association with the event.

10. The method of claim 1, further comprising automatically reserving admission to events meeting predetermined criteria.

11. A system, comprising:
one or more memories; and
one or more processors in communication with the one or more memories, the one or more processors configured to:
receive a request for information associated with a particular geographic area and particular time;
identify events scheduled to occur or having occurred within the geographic area during the particular time;
identify venue information associated with the identified events;
filter the identified events to produce a subset of events for display; and
provide for display the subset of events and the associated venue information in relation to geographic information associated with the events.

12. The system of claim 11, wherein the venue information comprises information indicating a number of people the venue is capable of accommodating.

13. The system of claim 11, wherein in providing the subset of events for display, the one or more processors are configured to provide a graphic for each event in the subset as an overlay on a map.

14. The system of claim 11, wherein filtering the identified events is based on one or more user preferences.

15. The system of claim 14, the one or more processors further configured to determine the one or more user preferences based on passive cues from the user.

16. The system of claim 14, the one or more processors further configured to determine the one or more user preferences based on historical information for the user.

17. The system of claim 14, wherein the one or more user preferences are indicated in a profile associated with the user.

18. The system of claim 11, the one or more processors further configured to provide for display event information, wherein a specific type of event information selected for display varies based on one or more search criteria in the request.

19. The system of claim 11, the one or more processors further configured to:
determine remaining availability for attending the event; and
provide the remaining availability for the event for display in association with the event.

20. The system of claim 11, further comprising automatically reserving admission to events meeting predetermined criteria.

21. A computer-readable medium storing instructions executable by one or more processors for performing a method, comprising:
receiving a request for information associated with a particular geographic area and particular time;
identifying events scheduled to occur or having occurred within the geographic area during the particular time;
identifying venue information associated with the identified events;
filtering the identified events to produce a subset of events for display; and
providing for display the subset of events and the associated venue information in relation to geographic information associated with the events.
